(19) United States
(12) Patent Application Publication
(10) Pub. No.: US 2007/0174470 A1
(43) Pub. Date: Jul. 26, 2007

(54) Device with cache command forwarding

(75) Inventors: Paul Burgess, Totten (GB); Steven Hayter, Christchurch (GB); Darren Hayward, Southampton (GB); David Trossell, Everton Lymington (GB)

Correspondence Address: BANNER & WITCOFF, LTD., 1100 13th STREET, N.W., SUITE 1200, WASHINGTON, DC, 20005-4051, US

(73) Assignee: Bridgeworks Limited, Christchurch (GB)

(21) Appl. No.: 11/637,195

(22) Filed: Dec. 12, 2006

(30) Foreign Application Priority Data
Dec. 15, 2005 (GB) GB 0525555.9

(51) Int. Cl. G06F 15/16

(52) U.S. Cl. 709/227

(57) ABSTRACT

In a bridge, a cache module is operable on receipt of a message pertaining to a write or other cacheable command from an initiator device to process the command so as to cause a suitable command to be passed to the relevant target device and to respond immediately to the initiator device with a ‘response good’ response. The ‘response good’ response is sent to the initiator device before the corresponding response pertaining to the cacheable command is received from the target device. When the cache module receives an error response from a target device, the cache module converts the response into a ‘deferred error’ response and passes this onwards to the initiator device. Since the initiator device receives a positive response sooner, it can send a subsequent command sooner and thus performance is increased.

### FIELD OF THE INVENTION

This invention relates to a device.

### BACKGROUND OF THE INVENTION

It is known to connect two networks together with a bridge. The networks may be of the same type, or they may be of different types. Example network types are SCSI (Small Computer Serial Interface), Fibre Channel, ISCSI (Internet SCSI), ATA (Advanced Technology Attachment), Serial ATA, Infiniband and Serial Attached SCSI, although there are many others. Bridges often connect a network to which a number of host stations are connected to a SAN (storage area network), although they can also be put to other uses. As well as performing any necessary communication protocol conversion, bridges can provide some additional functionality. Examples of bridges are the Potomac and Tamar bridge products vended by Bridgeworks Limited of 135 Somerford Road, Christchurch, Dorset, United Kingdom.

The invention is concerned with improving the performance of a device such as a bridge.

### SUMMARY OF THE INVENTION

The invention provides a device comprising:
first and second network connections,
processor means, and
memory,
   the processor means and the memory together operating to implement plural software modules including a cache module, the software modules being for allowing data to be passed between the first and second network connections and for handling the data as it passes between the first and second network connections, wherein the cache module is responsive to receiving a cacheable command from an initiator device connected to first network connection to respond to the initiator device with an indication that the cacheable command is good and to forward the cacheable command to a target device connected to the second network connection.

Embodiments of the invention will now be described by way of example only with reference to the accompanying drawings.

### BRIEF DESCRIPTION OF THE DRAWINGS

FIG. 1 is a schematic drawing illustrating certain a device according to the invention connected between two networks; and

FIG. 2 is a schematic drawing illustrating in more detail some of the components of the FIG. 1 device and its operation.

### DETAILED DESCRIPTION OF THE EMBODIMENTS

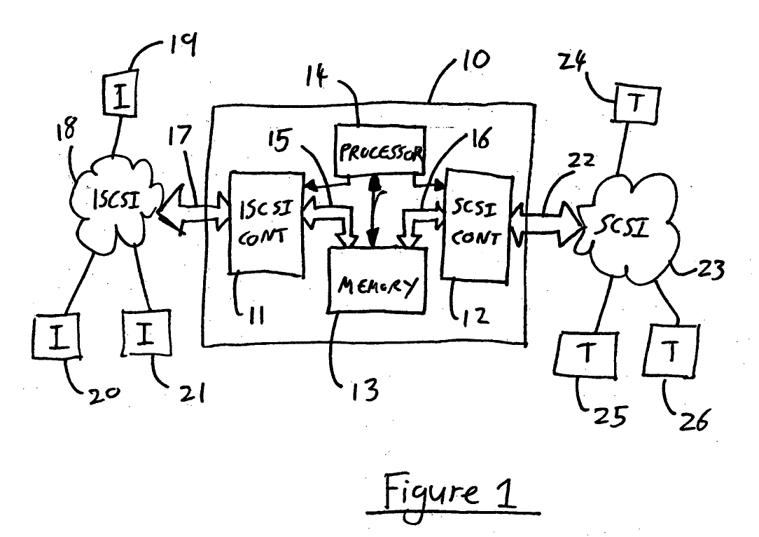

In the Figures, the same reference numerals are used for like elements throughout. Referring to FIG. 1, a device 10 in the form of a bridge includes an iSCSI controller 11, which here includes an associated IP (Internet Protocol) controller, a SCSI controller 12, a memory 13 and a processor 14. The processor effects control over the iSCSI and SCSI controllers 11, 12, and is operable with the memory 13 to execute software so as to perform its functions. Software is permanently stored in non-volatile memory (not shown). This software includes an operating system, upon which the bridge runs application software. The iSCSI and SCSI controllers 11, 12 are connected by respective internal buses 15, 16 to the memory 13. Clearly this Figure is merely schematic; the bridge also includes a power supply along with various other components not relevant to this explanation.

The iSCSI controller 11 is connected via an iSCSI connector 17 to a first network, here an IP network 18. In practise, the IP network 18 is able to carry IP (Internet Protocol) packets. iSCSI is a standard developed to allow SCSI packets to be carried within IP packets. An iSCSI packet basically comprises a SCSI packet as the payload of an IP packet including an IP header. Thus, the IP network 18 can also be termed an iSCSI SAN network. Connected to the iSCSI network 18 are a number of workstations, illustrated in the Figure as first, second and third Initiators 19, 20, 21.

The SCSI controller 12 is connected via an SCSI connector 22 to a second network, here in the form of an SCSI bus 23. Connected to the SCSI bus 23 are a number of storage devices, illustrated in the Figure as first, second and third Targets 24, 25 and 26.

The bridge 10 serves to connect devices on the first network 18 with devices on the second network 23. In this example, the bridge allows iSCSI devices in the form of the first, second and third Initiators 19, 20, 21 to utilise SCSI storage devices, such as hard disk or tape devices, in the form of the first, second and third Targets 24, 25 and 26 together comprising a SAN for storage of data and for the retrieval of data therefrom. As is described below, the bridge handles data in SCSI format. However, it will be understood that the invention is not limited to these network types, nor is it limited to the provision of access to a SAN nor to the handling of SCSI data.

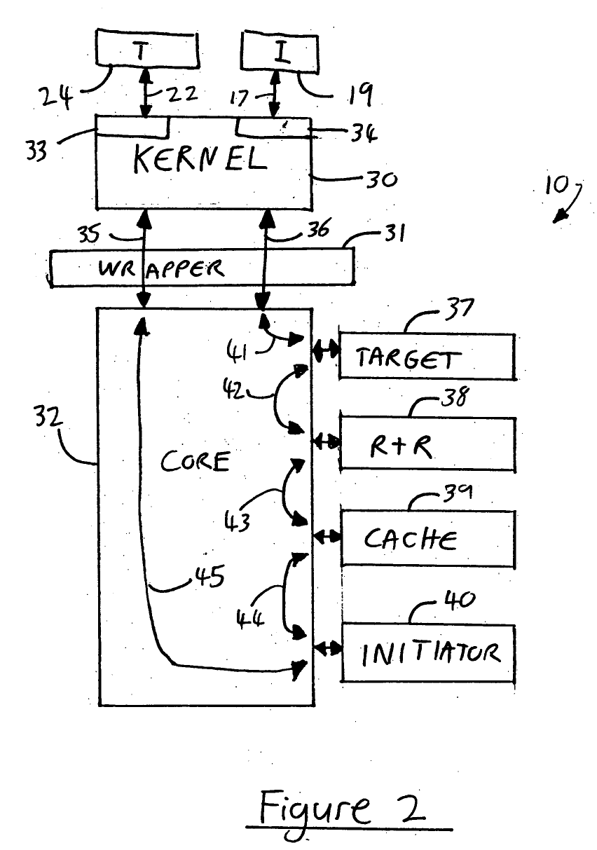

Referring now to FIG. 2, the bridge is shown in more detail. The bridge 10 is divided into functional blocks. In particular, the bridge comprises a kernel 30, a wrapper 31 and a core 32. The kernel 30 includes a SCSI interface portion 33, which is connected bidirectionally via the SCSI connector 22 to a Target 24. The kernel also includes an IP interface portion 34, which is connected bidirectionally via the iSCSI connector 17 to an Initiator 19. The SCSI interface portion 33 includes the IP controller 12 and some associated software. The IP interface portion 34 includes the IP controller 11, an Ethernet driver and some TCP/IP software. First and second bidirectional wrapper paths 35, 36 are made from the kernel through the wrapper 31 to the core 32.

The module core 32 includes an iSCSI target module 37, a reserve and release module 38, a cache module 39 and an SCSI initiator module 40 connected in series between the second bidirectional wrapper path 36 and the first bidirectional wrapper path 35. In particular, a first core path 41 connects the second bidirectional path 36 to the iSCSI target module 37, a second core path 42 connects the iSCSI target module 37 to the reserve and release module 38, a third core path 43 connects the reserve and release module 38 to the cache module 39, a fourth core path 44 connects the cache module 39 to the SCSI initiator module 40, and a fifth core path 45 connects the SCSI initiator module 40 to the first bidirectional path 35.

Each module, namely the iSCSI target module 37, the reserve and release module 38, the cache module 39 and the SCSI initiator module 40, is a software module. Each module 37, 38, 39 and 40 operates on a respective thread of the operating system. Thus, the modules 37, 38, 39 and 40 operate in parallel to one another.

On power-up of the bridge 10, the bridge is initialised. This is a four stage process. Firstly the memory 13 is preset. This sets up the memory in advance of operation of the bridge 10, and avoids the need to allocate memory on-the-fly. In this connection, the memory is preset to store information about modules, flags, pointers to queues, pointers to names, unique module identifiers and locations for modules etc. The second stage comprises resource allocation. In this stage, allocation is made for resources needed for the paths (for data and other communications) between modules 37, 38, 39 and 40, e.g. queues, semaphores and mutexes. These resources are allocated specifically for the modules 37, 38, 39 and 40. In the third-stage, the modules 37, 38, 39 and 40 are initiated. Each module has its own initiation function, e.g. concerning the caches needed for each target and initiator device. The fourth step is to order the modules according to their locations set in the second stage. The operation of the modules in processing messages and data will now be described.

Briefly, when a message, such as a command, is received from the initiator 19 at the IP interface portion 34, limited processing of it is performed by the kernel 30. After this limited processing, the kernel 30 stores information relating to the message, the raw data associated with the message, pointers to the raw data, and one or more IP addresses in the memory 13. The kernel 30 then produces one or more pointers to the message. The one or more pointers to the message then are passed to the wrapper 31, which uses the pointer(s) to obtain the message from the memory 13, and performs some modification of certain components of the message. The modified message then is passed via the first path 41 to the iSCSI target module 37. The iSCSI target module 37 extracts various items of information from the received modified message. The information that the iSCSI target module 37 extracts from the modified message includes: a pointers to a command description block (CDB), one or more pointers to the raw data, information identifying the number of pointers to raw data, a pointer to the target device that the message relates to, for instance a pointer to the target 24, a pointer to the initiator device 19, a pointer to the next data, an identifier which is unique to the SCSI data packet, a number of SCSI data flags (identified below), a reference count, information identifying the expected length of the data, information identifying the actual length of the data, a hash of the unique identifier of the initiator device, and a generic reason code.

The blocks of raw data for a message normally are stored sequentially in the memory 13. The pointer to the next data might be a pointer to data associated with a different message, and may be concerned with a different target device and/or a different initiator device. The hash of the unique identifier of the initiator device is used in place of the unique identifier itself since it has been found just as effective yet utilises a significantly reduced data overhead. The generic reason code can be used to reset modules, amongst other things.

The SCSI data flags indicate whether SCSI is cacheable, whether a SCSI CDB is sent, whether SCSI data is awaited, whether a SCSI reply is sent, whether the SCSI command has been sent to the SCSI controller 33, whether a SCSI device is awaiting release and whether a SCSI device is awaiting reserve. The generic reason code is either a general reason, a task management request reason or a response reason. The available general reasons are: fatal error, not supported, system shutdown and module shutdown. Typical iSCSI task management request reasons are: abort task, abort task set, clear ACA, clear task set, logical unit reset, target warm reset, target cold reset and task reassign. The available response reasons are: good, rejected, task non-existent, LUN (logical unit number) non-existent, task allegiant and authorisation failure.

The SCSI data message is processed by the iSCSI target module 37 according to the function provided by the software comprising the target module. The iSCSI target module 37 is the module that communicates most directly with the initiator 19. The SCSI Initiator module 40 serves as an interface to the protocol that the target 24 uses. When the iSCSI target module 37 has finished processing the iSCSI data message, the result is forwarded to the reserve and release module 38 via the second path 42. The SCSI data message passed to the reserve and release module 38 may have been modified by the iSCSI target module 37. Alternatively or additionally, the raw data pointed at by the pointers forming part of the SCSI data message may have been modified by the target module. The particular modification effected by the iSCSI target module 37 is not important to this explanation so is not described in detail here.

The SCSI data message received from the iSCSI target module 37 is processed by the reserve and release module 38 according to the function provided by the software comprising that module. In some cases, the reserve and release module 38 will return the SCSI data packet to the iSCSI target module 37 with a modified generic reason code. Normally, though, the reserve and release module 38 merely passes the SCSI data message via the third path 43 to the cache module.

The SCSI data message received from the reserve and release module 38 is processed by the cache module 39 according to the function provided by the software comprising the cache module. If the originating message.is a data write command, the processing effected by the cache module 39 processes the SCSI data message to modify it in such a way as to cause later the target device 24 to perform the required action. When the cache module 39 has finished processing the SCSI data message, the resulting SCSI data message is forwarded to the SCSI initiator module 40 via the fourth path 44. Depending on the contents of the SCSI data message and the programmed function of the cache module 39, the cache module may also send a SCSI data message back to the reserve and release module 38 for passing onwards to the initiator 19.

The SCSI data message received from the cache module 39 is processed by the SCSI initiator module 40 according to the function provided by the software comprising the initiator module. The SCSI initiator module 40 is the module that communicates most directly with the target 24. The SCSI initiator module 40 serves as an interface to the protocol that the initiator 19 uses.

When the SCSI initiator module 40 has finished processing the SCSI data message passed to it by the cache module 39, the resulting SCSI data message is forwarded to the wrapper 31 via the fifth path 45. The SCSI data message passed to the wrapper 31 may have been modified by the SCSI initiator module 40. Alternatively or additionally, the raw data pointed at by the pointers forming part of the SCSI data message may have been modified by the SCSI initiator module 40. The particular modification effected by the SCSI initiator module 40 is not important to this explanation so is not described in detail here.

The wrapper 31 performs some modification of certain components of the SCSI data message and passes the result to the kernel 30. The kernel 30 uses pointers and other information provided by the wrapper 31 to retrieve the information relating to the message, the raw data associated with the message, the pointers to the raw data, etc., and performs additional processing. The kernel then uses the SCSI interface portion 33 to send a suitable SCSI message to the target 24.

The bridge 10 functions similarly in the opposite direction. In particular, when a message, for instance a SCSI response (generated in response to a received command), is received from a target device, such as the target 24, limited processing of it is performed by the kernel 30. The kernel 30 stores information relating to the message, the raw data associated with the message, pointers to the raw data, one or more IP addresses, etc. The message then is passed to the wrapper 31, which performs some modification of certain components of the message, as is described in more detail below. The modified message then is passed via the fifth core path 45 to the SCSI initiator module 40 as a SCSI data message including various items of information. The information that the SCSI data message includes is the same as that described above.

The SCSI data message is processed by the SCSI initiator module 40 according to the function provided by the software comprising the initiator module. The processing of the SCSI initiator module 40 when operating on SCSI data messages passing in this direction is likely to be quite different to the processing performed on SCSI data messages passing in the opposite direction. This difference arises from differences in the contents of the SCSI data packets, and not from the initiator module responding differently depending on the direction in which the SCSI data packet is being sent. The resulting SCSI data packet is passed via the fourth core path 44 to the cache module 39.

The SCSI data message received from the SCSI initiator module 40 is processed by the cache module 39 according to the function provided by the software comprising the cache module. When the cache module 39 has finished processing the SCSI data message, the result may be forwarded to the reserve and release module 38 via the third path 43. Alternatively, a SCSI data message may be returned to the SCSI initiator module 40. Depending on the contents of the SCSI data message received at the cache module 38 over the third path 43 and the programmed function of the cache module 39, the cache module may also send a SCSI data message back to the SCSI initiator module 40.

The SCSI data message received from the cache module 39 is processed by the reserve and release module 38 according to the function provided by the software comprising that module. In some cases, the reserve and release module 38 will return the SCSI data packet to the cache module 39 with a generic modified reason code. Normally, though, the reserve and release module 38 merely passes the SCSI data message via the second path 42 to the iSCSI target module 37.

The SCSI data message received from the reserve and release module 38 is processed by the iSCSI target module 37 according to the function provided by the software comprising the target module. The target module 40 serves as an interface to the protocol that the target 24 uses. When the iSCSI target module 37 has finished processing the SCSI data message, the resulting iSCSI data message is forwarded to the wrapper 31 via the second path 42. The SCSI data message passed to the wrapper 31 may have been modified by the iSCSI target module 37. Alternatively or additionally, the raw data pointed at by the pointers forming part of the iSCSI data message may have been modified by the target module.

The wrapper 31 performs some translation of certain components of the iSCSI data message and passes the result to the kernel 30. The kernel 30 uses pointers and other information provided by the wrapper to retrieve the information relating to the message, the raw data associated with the message, the pointers to the raw data, the one or more IP addresses, and the iSCSI message formatted descriptor block stored in the memory 13 by the kernel previously, and performs additional processing. The kernel then uses the IP interface portion 34 to send a suitable iSCSI message to the initiator 19.

A conventional cache module in effect passes-through commands and responses without any modification thereof. In particular, when it receives a SCSI data message relating to a cacheable command (such as a write command) from an initiator device, a conventional cache module processes the command and passes a suitably modified SCSI data message to the appropriate SCSI storage target device. Processing the cacheable command involves temporarily storing it in a cache element forming part of the cache module 39. The cache module 39 includes a sequential set of plural cache elements (not shown), each of which is capable of storing one cacheable command. On subsequently receiving a response from the SCSI storage target device, as part of a SCSI data message, a conventional cache module passes a suitable SCSI data message back to the initiator device. In accordance with the SCSI standard, the response can take one of a number of forms. In particular, the response may be a ‘response good’ message, indicating that the write command and corresponding data has been accepted by the SCSI target device. The response may alternatively be an ‘error’ response, indicating that the write command was not accepted by the SCSI target device. There are a number of other responses which can validly be made.

For instance, if a write command was accepted by a SCSI target device, which therefore issues a ‘response good’ response, and is subsequently found by the SCSI target device not to be executable for some reason, the SCSI target device issues a ‘deferred error’ response. On receiving such a response, a conventional cache module passes the ‘deferred error’ response back to the appropriate initiator device. According to the SCSI standard, an initiator device on receiving such a ‘deferred error’ response is entitled to send a message requesting from the SCSI target device information concerning the nature of the error. A conventional cache module is operable to pass through such a message to the SCSI target device, and also to pass through the response of the SCSI target device to the initiator's request. The response may include information concerning the error, or it may indicate that the ability to provide information concerning the error is not supported by the SCSI target device.

The bridge 10, in particular the cache module 39 thereof, of this embodiment is non-conventional. In particular, the cache module 39 is operable on receipt of a SCSI data message pertaining to a write command or a different cacheable command from an initiator device to process the command so as to cause a suitable command to be passed to the relevant SCSI target device and to respond immediately to the initiator device with a ‘response good’ response. The ‘response good’ response is sent to the initiator device before the corresponding response pertaining to the cacheable command is received from the SCSI target device. The ‘response good’ response can be said to be sent from the cache module 39 in response to receiving the cacheable command, instead of in response to receiving a ‘response good’ response from the SCSI target device as is conventional. This can be termed auto-response good operation.

The cache module 39 includes non-conventional response handling features. In particular, when the cache module 39 receives an error response from a SCSI target device, the cache module 39 converts the response into a ‘deferred error’ response and passes this onwards to the initiator device. In this way, the initiator device that generated the originating write command is informed that there was an error in executing the cacheable command, - and updates its internal structures to signify that the data was incorrectly written to the SCSI storage device.

The cache module 39 will manage the ‘response good’ response from a SCSI target device for a command that has already has received an auto- response good response issued by the cache by deleting the response, such that it is not forwarded to the initiator device. This avoids initiator devices receiving two ‘response good’ responses in respect of a write command that has been correctly executed by a SCSI target device.

On receiving a non-cacheable command, such as a read command, the cache module 39 does not immediately send a response good to the initiator device. Instead, the non-cacheable command is sent to the target device to which it is addressed and a response is awaited. When received at the cache module 39, the response is forwarded to the appropriate initiator device.

Furthermore, on receiving a non-cacheable command from an initiator device, the cache module 39 temporarily inhibits auto-response good responses to any cacheable commands subsequently received by the cache module from other initiators. When a response to the non-cacheable command is received from the target device to which the command was addressed, the cache module 39 forwards the response to the originating initiator. The cache module 39 then processes the commands which remain cached in the cache elements of the cache module 39. For cacheable commands present in the cache elements, the cache module 39 performs an auto-response good operation to the issuing initiator device. On finding a non- cacheable command in a cache element, the cache module 39 waits for a response to the command from the relevant target device before proceeding to handle the next command in the sequential set of cache elements.

On receiving a command from an initiator, the cache module 39 determines whether the sequential set of cache elements is full, in which case accepting the command would exceed the maximum permissible number of elements within the cache module 39. If it is determined that the sequential set of cache elements is full, the cache module 39 generates a “task set full” response and sends it to the initiator device that the command was received from. The cache module 39 then discards the received command and its associated data. Upon receiving the task set full response, the initiator device pauses for a random time before resending the same command.

The cache module 39 is further operable on receiving a command from an initiator requesting information about a write error to provide to the initiator device a response indicating that the feature of providing such information is not supported. In this way, the bridge 10 can achieve the benefits (described below) of the auto- response good mode of operation whilst providing the initiator device with the technically important information, i.e. that there was an error response to a write command. Furthermore, this is achieved without breaching the terms of the SCSI standard.

When receiving a ‘deferred error’ response from a SCSI target device, the cache module 39 passes the response through to the appropriate initiator device. A ‘deferred error’ response typically occurs when there is a media error, a write error or an end of tape is encountered. If subsequently the cache module 39 receives from the initiator device a request for information relating to the error, this is passed-through by the cache module 39 to the SCSI target device. Any response subsequently received from the SCSI target device then is passed-through by the cache module 39 to the relevant initiator device.

On receiving a message from a target device indicating that a recovered error occurred, the cache module 39 deletes the message and does not forward anything corresponding to the initiator device that the message was addressed to. A recovered error can occur for instance when there is a corrupt section of tape in a tape storage device and the tape storage device wrote the data in a different section of tape instead.

When operating the cache module 39 in the auto-response good mode of operation, locations are allocated to the cache and reserve and release modules 39, 38 so that the reserve and release module 38 is between the cache module 39 and the iSCSI target module 37. Without this, the number of ‘response good’ responses incorrectly generated by the cache module 39 might increase to undesirable levels.

The inventors have found that operating the cache module 39 in the auto-response good mode of operation increases the performance of the bridge 10 significantly. In tests involving a bridge having a particular hardware arrangement and operating to write data from an iSCSI initiator device to a SCSI tape storage device on opposite sides of the bridge, the data transfer rate was found to be increased by 111% from when the cache module 39 was operated conventionally to when the cache module 39 operated in the auto-response good mode of operation. In a test involving a bridge having a particular hardware arrangement and operating to write data from an ISCSI initiator device to a SCSI disk storage device on opposite sides of the bridge, the data transfer rate increased also by 111% from when the cache module 39 was operated conventionally to when the cache module 39 was operated in the auto-response good mode of operation. Different performance improvements are obtained from different test scenarios. These performance improvements are obtained because an initiator device receives a ‘response good’ response in respect of a write command more quickly than would occur if the cache module 39 had not automatically issued a ‘response good’ response but had instead passed-through the ‘response good’ response from the SCSI target device when it received it. Since the ‘response good’ response is received at the initiator sooner, the initiator device is able to issue the next write command sooner. It is the reduced interval between successive write commands issued by the initiator that gives rise to the performance improvement.

Although the auto-response good has been described with reference to SCSI target devices and the iSCSI standard, it will be appreciated that it is applicable also to other communication techniques, whether standardised or not. If the communication protocol is standardised, the auto-response good feature is applicable if that the standard allows for error responses to be sent after a response indicating that a write command was accepted has been issued.

The number of cacheable elements within the cache module 39 is able to be varied through software control. This allows increased performance of the bridge 10. In particular, the inventors have found that the performance of the bridge 10 in terms of speed of command handling depends on there being an appropriate number of cacheable elements in the cache module 39. If there are too few cacheable elements, performance can be sub-optimal since the sending of cacheable command by initiator devices can be inhibited if there is a small delay in the performance of those commands by one or more target devices. If there are too many cacheable elements in the cache module 39, performance can be sub-optimal since the holding of a large number of cacheable commands can utilise hardware resources of the bridge which otherwise could be used to better effect in handling commands and responses. Thus, allowing the number of cacheable elements within the cache module 39 to be varied through software control allows the caching of a maximum number of commands which is appropriate having regard to the tasks that the bridge 10 performs and the hardware resources that are available to it, thereby to increase the performance of the bridge 10.

To further advantage, the number of cacheable elements within the cache module 39 is dynamically variable by control software in the bridge 10. Here, the bridge 10 monitors over time the number of cacheable commands stored in the cache and uses the result to determine how many cacheable elements to include within the cache module 39. Thus, if the bridge 10 determines that the number of cacheable commands stored in the cache module, averaged over a period of time, is significantly below the maximum number of cacheable elements present, the bridge 10 reduces the number of cacheable elements. The memory resources thereby freed-up can then be used by other parts of the bridge 10 to improve the performance thereof. Conversely, if the bridge determines that all the cacheable elements contain cacheable commands for greater than a predetermined proportion of a time period, the bridge 10 increases the number of cacheable elements present in the cache module 39, thereby allowing more cacheable commands to be stored at a time.

Instead of having a single cache module 39 present in the module core 32, there may be plural caches in parallel with one another in the module core 32. In this case, each cache module may be dedicated to a respective target device. Thus, when a cacheable command is received from an initiator device, it is passed to the one of the plural cache modules which is dedicated to the target device to which the command is addressed.

In the above, pointers to the raw data are passed through the module core 32, and the data itself remains in the memory 13. Alternatively, the raw data can be passed through the module core 32 and the modules 37-40 along with the SCSI data messages.

Although the invention has been described applied to a bridge 10 having two network connections, the invention is not limited to this. Instead, the invention is applicable to any device which has two or more network connections. For instance, providing a device incorporating three different network connections can allow initiator devices of different types to access storage devices of a particular type connected on a SAN by connecting the initiator devices to different network connectors on the device. For instance, iSCSI and Fibre Channel initiators both can access SCSI storage devices by providing a device comprising a SCSI network connection and Fibre Channel and IP network connections. Alternatively, there may be plural SANs, operating according to the same or according to different protocols. The SANs may be accessible by one, two or more different types of initiator device.

What is claimed is:

1. A device comprising:
first and second network connections,
processor means, and
memory,
the processor means and the memory together operating to implement plural software modules including a cache module, the software modules being for allowing data to be passed between the first and second network connections and for handling the data as it passes between the first and second network connections, wherein the cache module is responsive to receiving a cacheable command from an initiator device connected to first network connection to respond to the initiator device with an indication that the cacheable command is good and to forward the cacheable command to a target device connected to the second network connection.

2. A device as claimed in claim 1 wherein the cache module is responsive to receiving a non-cacheable command from an initiator device to forward the command to a target device via the second network connection and to respond to the initiator device with an indication that the non-cacheable command is good following such a response being received from the target device.

3. A device as claimed in claim 1, wherein the cache module is responsive to receiving a response from a target device to a cacheable command sent to the target device that indicates that the cacheable command was good by preventing the forwarding of the response to the initiator device.

4. A device as claimed in claim 1, wherein the cache module is responsive to receiving a response from a target device that indicates that a correctable error was generated in respect of a cacheable command by preventing the forwarding of the response to the initiator device.

5. A device as claimed in claim 1, wherein the cache module is responsive to receiving a response from an target device that an error occurred in the handling of a cacheable command to send a deferred error response in relation to that command to the initiator device.

6. A device as claimed in claim 1, wherein the cache module is responsive to receiving a command from an initiator device requesting information about an error occurring from a cacheable command to provide to the initiator device with a response indicating that the feature is not supported.

7. A device as claimed in claim 1, wherein the cache module is responsive to receiving a command from an initiator device requesting information about an error to provide to the initiator device with a response indicating the nature of that error

8. A device as claimed in claim 1, wherein the cache module is responsive to receiving a non-cacheable command from an initiator device to inhibit the generation by the cache module of response good responses to received cacheable commands until a response to the non-cacheable command from the target device to which the command was addressed is received at the cache module.

9. A device as claimed in claim 1, wherein the cache module is able to vary via software control the number of cacheable elements within the cache.

10. A device as claimed in claim 9, wherein the cache module is operable to monitor over time the utilisation of the cacheable elements within the cache and to vary dynamically the number of cacheable elements accordingly.

11. A device as claimed in claim 1, wherein when all cache elements are occupied the cache module is responsive to receiving a command to respond with a task-set- full message.

12. A device as claimed in claim 1, wherein the device includes only a single cache module.

13. A device as claimed in claim 1, wherein the device includes plural cache modules, each cache module being allocated to handle commands sent in respect of a different target device
